(19) United States
(12) Patent Application Publication
(10) Pub. No.: US 2008/0012427 A1
(43) Pub. Date: Jan. 17, 2008

(54) Power converter with integral battery

(76) Inventors: Scott Wilson, Phoenix, AZ (US); Charles M. Reynolds, Phoenix, AZ (US); Walter Thornton, Scottsdale, AZ (US); Kristie Valdez-Wurtz, Scottsdale, AZ (US)

Correspondence Address: JACKSON WALKER LLP, 901 MAIN STREET, SUITE 6000, DALLAS, TX, 75202-3797, US

(21) Appl. No.: 11/510,965

(22) Filed: Aug. 28, 2006

Related U.S. Application Data
(60) Provisional application No. 60/830,783, filed on Jul. 13, 2006.
(60) Provisional application No. 60/830,826, filed on Jul. 14, 2006.

(51) Int. Cl. H02J 9/00

(52) U.S. Cl. 307/66

(57) ABSTRACT

A portable and lightweight power converter adapted to power a portable electronic device, and in addition, which includes a high power battery adapted to provide an output DC voltage to operate and/or charge a portable electronic device when no source power is present. Advantageously, the power converter includes converter circuitry as well as a high power battery packaged as an extremely small device, and further configured to charge a battery of a portable electronic device multiple times with recharging. The converter may further include charging circuitry configured to charge the converter battery when input power is connected.

### CLAIM OF PRIORITY

This application claims priority of U.S. Provisional Ser. No. 60/830,783, entitled MAC WITH INTEGRAL BATTERY, filed Jul. 13, 2006, and also U.S. Provisional Ser. No. 60/830,826, entitled MAC WITH INTEGRAL BATTERY, filed Jul. 14, 2006.

### FIELD OF THE INVENTION

The present invention is directed to PORTABLE power converters and more particularly to PORTABLE power converters suited to power portable electronic devices including PDA's, cell phones, MP3 players, computing devices, digital cameras, game devices and the like.

### BACKGROUND OF THE INVENTION

Power converters are conventionally employed to charge and/or operate various battery operated devices. Certain power converters adapted to power portable electronic devices, including PDA's, cell phones, MP3 players, digital cameras, computing devices, game devices, and the like are typically configured to receive either an AC input voltage or a DC input voltage, or both, and convert this input voltage to a DC output voltage. The DC output voltage may have a selectable value, which may be established using interchangeable programming modules such as tips, such as those marketed as iTips™ by Mobility Electronics, Inc. of Scottsdale Ariz., the assignee of the present invention. These power converters are well suited to power portable electronic devices from various available power sources, including automobiles, airplanes and wall power. In combination with the interchangeable programming modules, a user need only carry a single power converter and one or more programming modules suited to establish the DC output voltage and power a suitable portable electronic device.

There is desired an improved portable power converter adapted to provide more conveniences to the user, including mobile users who occasionally are away from a power source and yet have a portable electronic device having a drained battery.

### SUMMARY OF INVENTION

The present invention achieves technical advantages as a portable power converter adapted to power and/or recharge a portable electronic device, and in addition, which includes a high power battery adapted to provide an output DC voltage to operate and/or charge a portable electronic device when a source of power is not available. Advantageously, the power converter including the high power battery is packaged as an extremely small and lightweight device, and further is configured to charge a battery of a portable electronic device multiple times with recharging.

### BRIEF DESCRIPTION OF THE DRAWINGS

FIG. 1 depicts a perspective view of a compact power converter having a single input and an integral battery according to one preferred embodiment;

FIG. 2 is a perspective view of an alternative embodiment configured to receive either an AC or a DC input voltage;

FIG. 3 is a schematic block diagram of a converter circuit for the device shown in FIG. 1;

FIG. 4 is a schematic block diagram of an alternative converter circuit for the embodiment of FIG. 1, including an integral charger for charging the integral battery;

FIG. 5 is an electrical block diagram of another electrical circuit including a high power battery, which may also include a DC voltage input;

FIG. 6 shows a detailed electrical schematic of one embodiment of the invention;

FIG. 7 shows a detailed schematic of the buck converter of FIG. 6;

FIG. 8 shows a detailed schematic of the control circuit of FIG. 6;

FIG. 9 shows a detailed schematic of the AC/DC converter of FIG. 6; and

FIG. 10 shows a detailed schematic of the SEPIC converter of FIG. 6.

### DETAILED DESCRIPTION OF THE PRESENT INVENTION

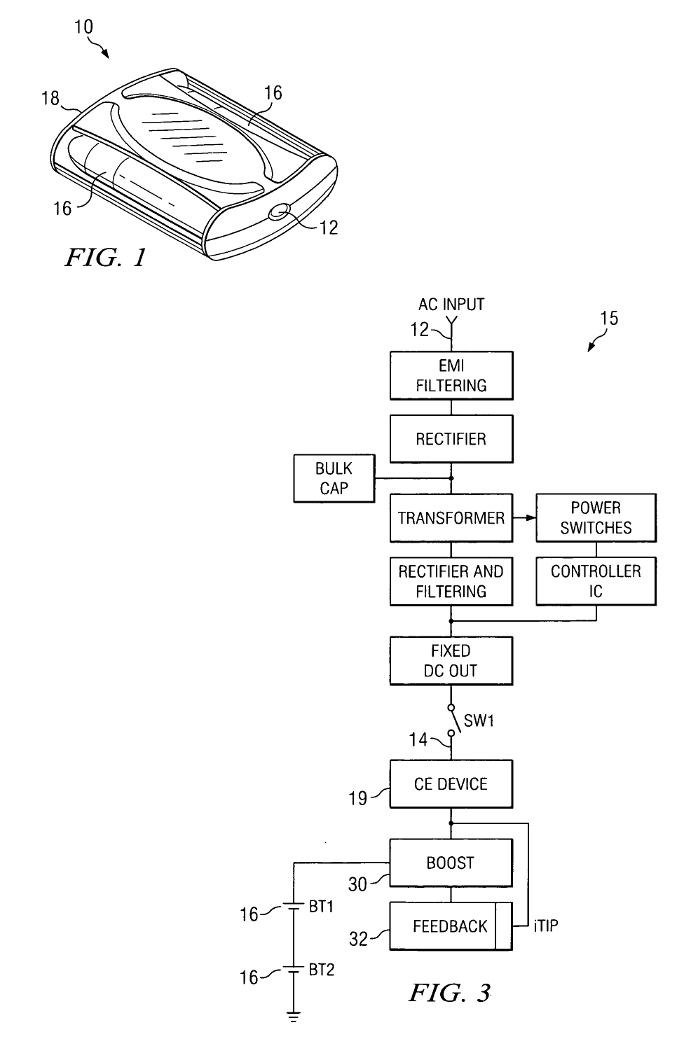

Referring now to FIG. 1, there is generally shown at 10 a perspective view of a compact portable power converter configured to receive an AC voltage at an input connector 12 and provide a converted voltage as a DC voltage to output 14, as shown in FIG. 3. Further shown in FIG. 1 is a plurality of batteries 16, one disposed on each side of the converter and viewable through a transparent portion of a housing generally shown at 18.

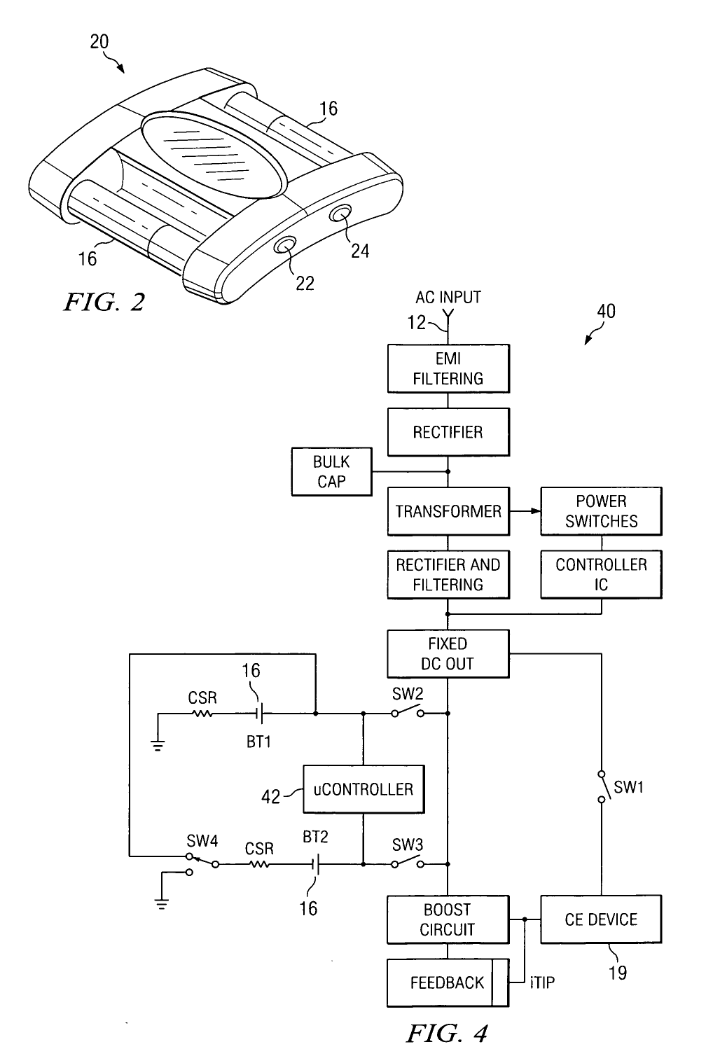

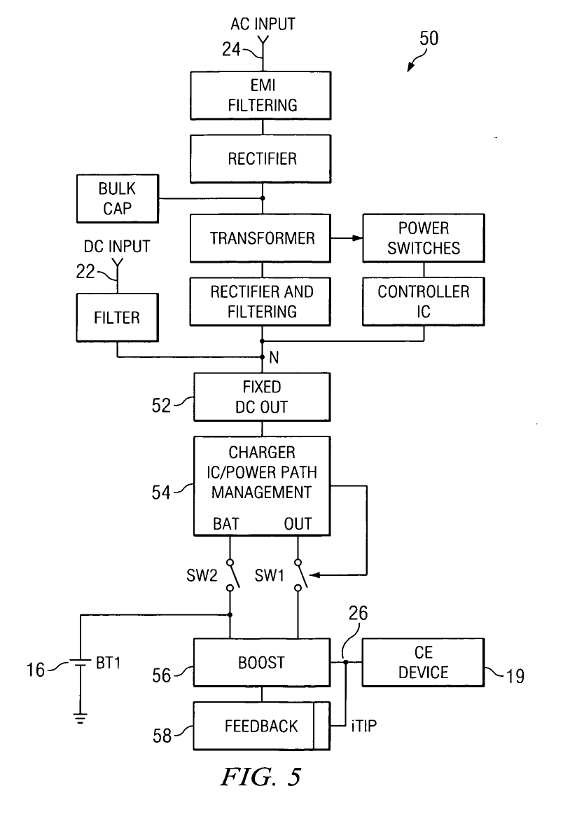

Referring now to FIG. 2, there is shown an alternative embodiment of the present invention at 20, seen to comprise a compact portable power converter having a pair of inputs, input 22 adapted to receive a DC input voltage, and input 24 adapted to receive an AC input voltage. Converter 20 includes an output 26 configured to provide a selectable DC output voltage at 26, and shown in FIG. 5. Advantageously, each of the compact portable power converters 10 and 20 have a high power battery, with the battery and electronic converter circuitry all packaged in a very small housing, thereby realizing a very high power density.

The present invention achieves technical advantages in that the power converter includes a high power and lightweight battery, such as a Lithium Ion battery, or a Lithium Polymer battery, enclosed with the converter circuitry in the small housing such that the converter itself is portable, and preferably half the size of a typical portable electronic device to be powered. For instance, the converter may be the size of a PDA. Further, the battery is configured to recharge the battery of a portable electronic device numerous times, without needing to be recharged itself, providing a mobile user the ability to repeatedly charge the same device, or charge multiple devices, using a portable and compact device. Moreover, the battery is automatically recharged when source power is provided by a charging circuit. This high power and compact power converter is light weight, and can be conveniently carried with other portable electronic devices providing the user with true power anywhere and anytime.

For instance, in one preferred embodiment, the power converter may be configured to provide up to 5 watts of continuous power, sourced from either the input power or the battery, with the housing having a volume of less than 6.80 cubic inches such as having dimensions of 1.10×2.05×3.0, to realize a power density of at least 0.75 watts/cubic inch, and have a weight of 3.5002, operating below 75° C. In one exemplary embodiment, the power density is at least 1 watt per cubic inch, whereby the package has a volume of about 5 cubic inches. The size of the housing, in one preferred embodiment, may be 0.98×1.8×2.53 inches, such that the housing has a volume of 4.46 cubic inches, realizing a power density of 1.12 watts per cubic inch, having a weight of less than 3.5 oz and operate under 75° C., although limitation to these dimensions and power is not to be inferred.

In another preferred embodiment, the power converter may provide up to 15 watts of continuous power. It is highly desirable and advantageous that the present invention provides a power density of at least 0.75, and preferably at least 1.0. In one exemplary embodiment, the power converter provides up to 10 watts of continuous power and has a volume of less than about 13.33 cubic inches, realizing a power density of 0.75, having a weight under 8 oz and operating under 75° C. The housing may also have a volume of less than 7 cubic inches, such as having a dimension of 1.09×1.99×2.97 inches to realize a volume of 6.48 cubic inches, and a power density of at least 1.23 watts per cubic inches for 10 watts of continuous output power, having a weight under 7 oz and operating under 75° C.

Volume, power density, weight, and rechargeability are some of the advantageous features of the present invention which provide numerous technical advantages to users needing power while on the go. Further, the output voltage may be selectable, so as to provide a suitable output voltage and/or current required to properly operate a portable electronic device, and/or recharge the battery thereof.

Referring now to FIG. 3, there is shown one electrical block diagram of circuit 15 which may be embodied in power converter 10. Notably, a pair of batteries 16 configured in series are coupled to a boost circuit 30 suited to increase the voltage provided by the batteries to a suitable voltage commensurate with the input voltage requirements of the portable electronic device, shown at 19. The batteries 16 may be rechargeable or disposable as desired. A feedback circuit 32 is configured such that the boost circuit 30 provides a suitable output voltage to the device 19 even as the voltage of the batteries 16 may vary or diminish over time, such as when the batteries become depleted. The circuit 15 converting the AC input voltage to the DC voltage may be a conventional fly back topology typically used in AC to DC converters, as shown. Switch SW1 is closed when device 19 is powered by the DC voltage derived from input 12, but is closed when device 19 is powered by batteries 16.

Referring now to FIG. 4, there is shown an alternative electrical block diagram of a circuit 40 which may be employed in power converter 10, seen to include the batteries 16 configured in parallel when switch SW4 is open, or inseries when switch SW4 is closed, as shown, and further configured to be automatically charged when AC input voltage is provided to input 12. A microcontroller 42 provides primary detection and monitoring of the battery voltages, temperature, and output current when delivering power to the device 19. When the AC input voltage is present, switches SW1, SW2 and SW3 are closed, whereby the device 19 is provided the output DC voltage, and the batteries are also simultaneously charged. Individual channel charging and series discharging is provided. During discharge, the voltage provided by the batteries is boosted to provide an adequate output voltage.

Referring now to FIG. 5, there is shown an electrical block diagram of one preferred embodiment of the converter circuit at 50 which includes a high power battery 16, comprising of, for instance, a Lithium Ion battery or a Lithium Polymer battery having a high power storage, high power density, and is lightweight. When an AC voltage is provided at input 24, switches SW1 and SW2 are closed. During this time, both the device 19 and the battery 16 are charged. Circuit 50 further includes a DC input 32 configured to receive and provide a DC input voltage to common node N and feeding a common output circuit shown at 52. A charger/power path management circuit 54 is configured to control switches SW1 and SW2, whereby the switches are opened by circuit 54 when no input voltage is provided to either of inputs 22 or 24. Boost circuit 56 boosts the DC voltage provided by circuit 54, if necessary, to provide a DC output voltage at 26 suitable for charging and/or operating the portable electronic device 19. Feedback circuit 58 regulates the boost circuit 56 as a function of the output voltage at 26 provided by the boost circuit 56, as shown.

With reference to all circuits shown in FIG. 3, FIG. 4 and FIG. 5, the respective feedback circuit may include an interchangeable programming component, such as an interchangeable device connector tip configured to control the respective boost circuit to selectively establish the DC output voltage provided to the converter circuit output 26. As noted previously, interchangeable programming tip connectors, such as the iTips™ provided by Mobility Electronics, Inc. may be utilized so that the user may establish both the proper DC output voltage and a suitable mechanical interface for connecting to and operating the portable electronic device 19. This additional voltage programming feature integrated into the compact power converter having a high power battery backup provides a unique solution for the mobile user needing flexibility to power different devices when no source power is available. The present invention is more than a power converter with a battery backup. It is a solution which comprises a compact device, has a high power density, is lightweight, and which automatically charges the battery when power is present, and provides power on demand when source power is not present.

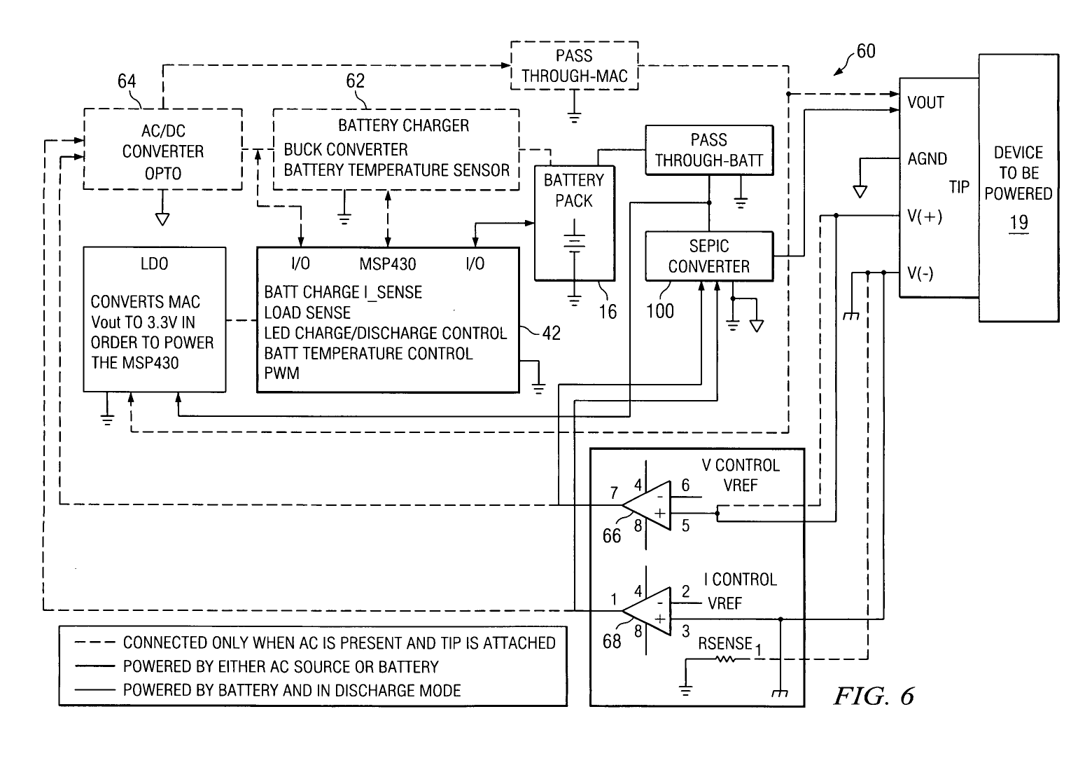

Referring now to FIG. 6, there is shown a detailed schematic diagram of an exemplary preferred embodiment of the present invention wherein like numerals refer to like elements. The battery 16 may be a NCS 1400 mAh batteries, and the converter 60 may generate up to 8 W continuous DC power. Most polymer Li-ion/Li-ion battery will have the same charging characteristics. It is assumed in this embodiment that the battery contains all protection circuitry that monitors temperature, over voltage, and over current. The battery pack may also contain a fuel gauge.

If there is a device 19 attached to the converter 60, the battery 16 may be charged using constant current ˜0.2 C or 280 mA until the battery voltage reaches 4.2 V. Once the battery reaches 4.2 V, the charge may then switch to constant voltage and the current may taper to 40 mA or less. The total charge time should be around 5 hours. During this time, the current available to a portable electronic device 19 may be limited to ˜570 mA.

When there is no device 19 attached, the charge rate may be ˜0.6 C or 850 mA until the battery voltage reaches 4.2 V. Once the battery 16 reaches 4.2 V, the charge may then switch to constant voltage and the current may taper to 40 mA or less. This should yield a charge time of about 2 hours.

The MSP430 microcontroller 42 continuously monitors the battery temperature with an external sensor, charge current, and charge voltage. The microcontroller 42 also monitors the unit to see when there is a load attached, such as device 19. If a load is attached, it will give precedence to the device 19 and provide less of a charge current to the battery 16.

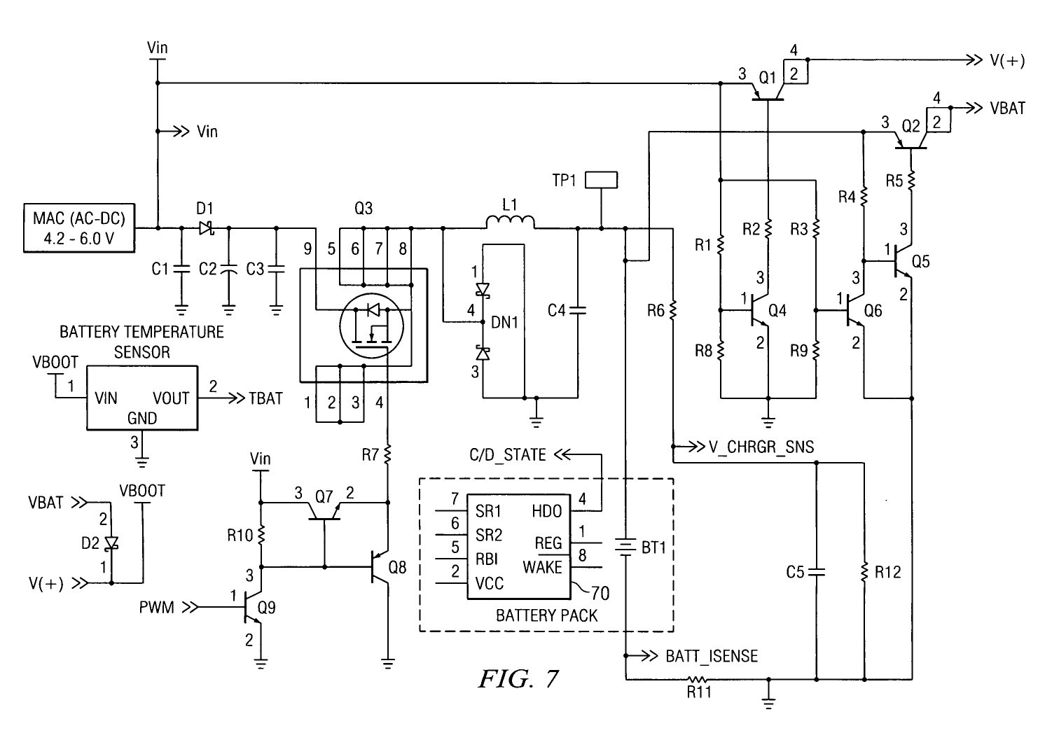

Referring now to FIG. 7, there is shown the buck converter 62. The maximum open circuit voltage from the AC/DC conversion circuit 64 may be 6.42 V. The buck converter 62 bucks the voltage from the converter circuit 64 down to 4.2 V so that it can charge the battery 16. The MSP430 constantly monitors the battery voltage and the input of the buck converter and provides regulation to the battery 16. The switching frequency of the MSP430 may be 173 kHz. This is based on a resolution of 5 bits. Resistor R11 senses the battery charge current while the battery voltage is sensed at the resistor R6 node.

Transistors Q1, Q4 and the accompanying resistors act as the pass through from the AC/ DC converter 64 and to the tip 19. Transistors Q2, Q5, and Q6 act as the pass through when using the battery 16 as the power source to the tip 19.

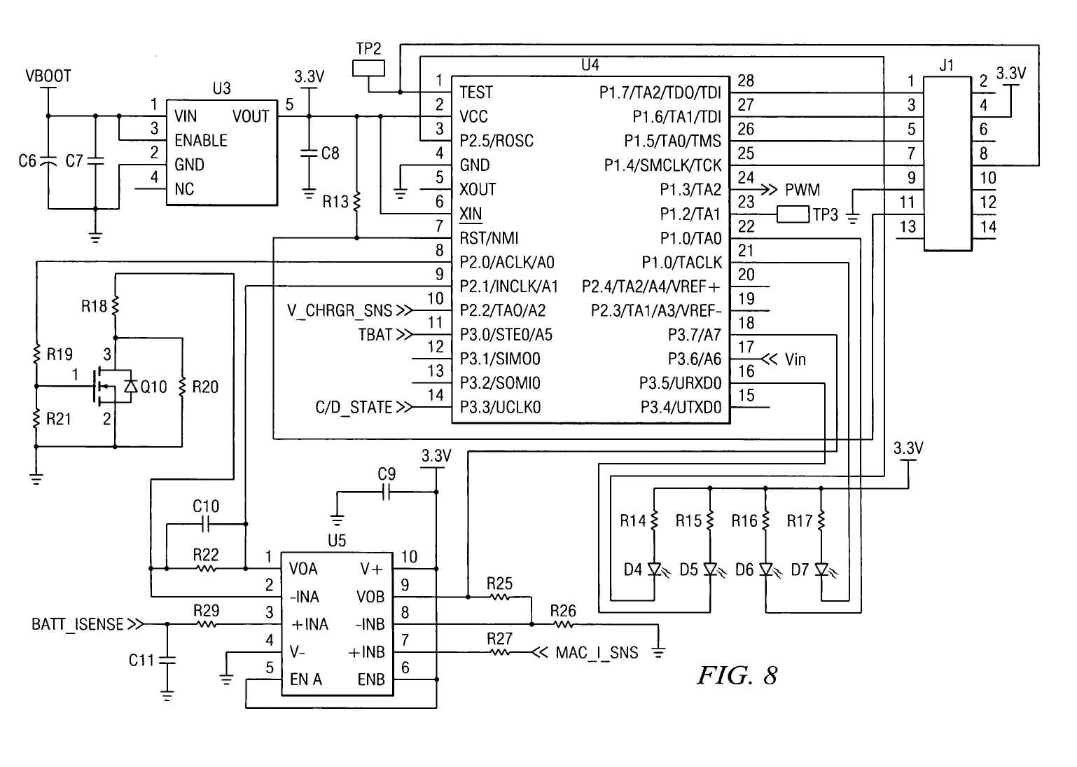

Referring now to FIG. 8, the LDO 80 provides 3.3 V to the VCC pin of the MSP430 42 and all the circuitry. Circuit U5 compares signals of the battery current sense as well as the load sense from the AC/DC converter 64 and provides information the MSP430. As stated above, if a portable electronic device 19 is attached while charging the battery 16, MSP430 will reduce the battery charge current to a standard rate of ˜0.2 C and give precedence to the device 19 providing up to 570 mA of current.

Four bi-colored LEDs D4-D7 provide information viewable by the consumer at 25-100% charge and discharge states. The MSP430 processes information from the battery fuel gauge 70 and then drives the LEDs accordingly. The fuel gauge may not be needed since the MSP430 has the capability of performing the same function.

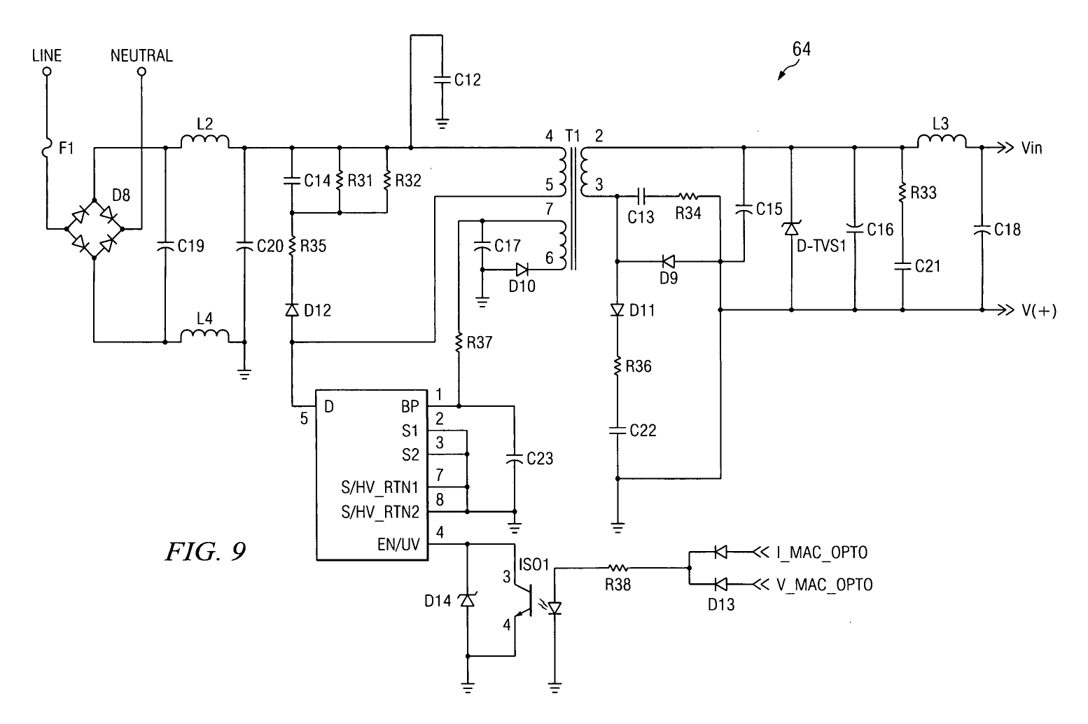

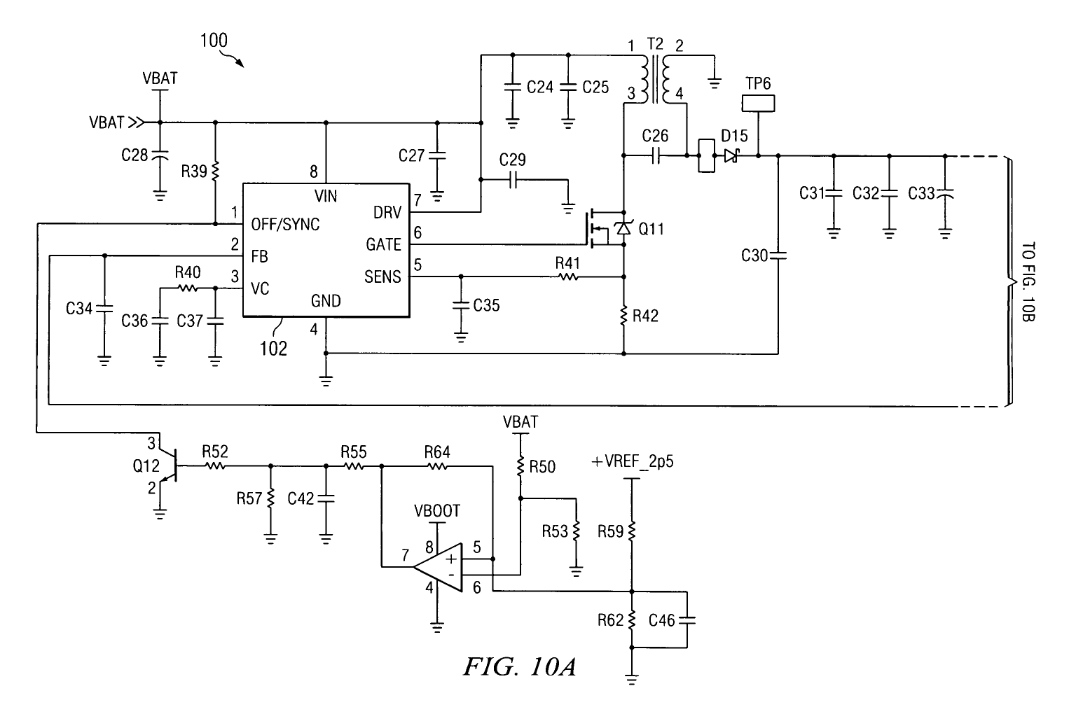

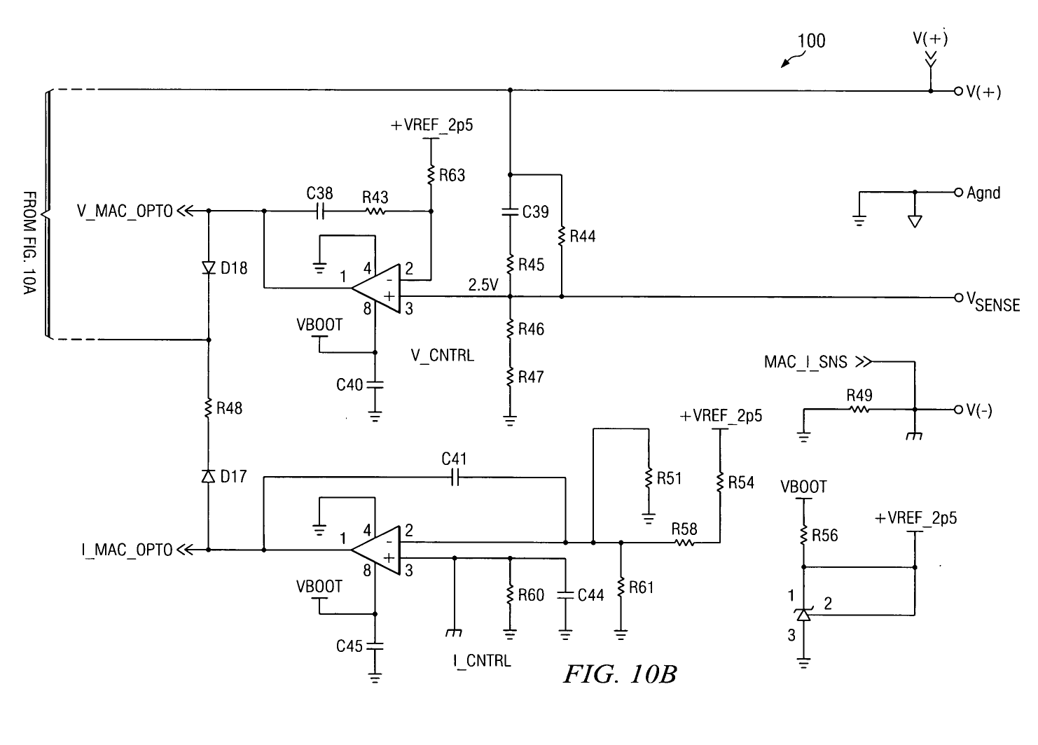

Referring now to FIG. 9 there is shown a detailed electrical schematic of AC/DC converter 64. Referring now to FIG. 10, there is shown SEPIC converter 100. The LTC1619 device shown at 102 is a low voltage PWM converter configured to a SEPIC converter. This circuit applies when the battery 16 is utilized as the power source for discharging to the tip and also for voltage and current sensing for the AC/DC regulation. All circuitry is power by the battery with the exception of the voltage and current sensing op-amps 66 and 68 which are powered by the AC/DC converter 64 when an AC source is present to converter 64.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A power converter, comprising:
a housing;
a power converter circuit disposed in the housing and having an input configured to receive either an AC voltage or a DC voltage, and provide a converted DC output voltage at an output;
a battery disposed in the housing and configured to provide a DC voltage to the output when no voltage is provided to the input; and
wherein the battery is configured to couple to electrically and operate or charge a portable electronic device, wherein the battery is configured to generate power up to 15 watts, and a power density of at least 0.75 watts/cubic inch.

2. The power converter as specified in claim 1 wherein the power converter has a power density of at least 1.0 watts/cubic inch.

3. The power converter as specified in claim 2 wherein the power density is at least 1.2 watts/cubic inches.

4. The power converter as specified in claim 1 wherein the power converter battery is configured to generate continuous power up to 10 watts and the housing has a volume of less than about 13.33 cubic inches.

5. The power converter as specified in claim 4 wherein the battery is configured to continuously generate power of up to 5 watts and the housing has a volume of less than about 6.67 cubic inches.

6. The power converter as specified in claim 4 wherein the power converter has a power density of at least 1.0 watts/cubic inch.

7. The power converter as specified in claim 5 wherein the power converter has a power density of at least 1.0 watts/cubic inch.

8. The power converter as specified in claim 6 wherein the housing has a volume of less than about 6.48 cubic inches.

9. The power converter as specified in claim 7 wherein the housing has a volume of less than about 4.46 cubic inches.

10. The power converter as specified in claim 1 wherein the DC output voltage is selectable.

11. The power converter as specified in claim 10 further comprising a removable program module configured to establish the value of the DC output voltage.

12. The power converter as specified in claim 11 wherein the removable program module comprises a tip connector configured to mechanically and electrically couple to the portable electronic device.

13. The power converter as specified in claim 1 wherein the battery is configured to fully charge a battery of the portable electronic device at least 2 times without charging.

14. The power converter as specified in claim 1 further comprising a charging circuit configured to charge the battery when the voltage is provided to the input.

15. The power converter as specified in claim 14 wherein the charging circuit automatically charges the battery when the voltage is provided to the input.

16. The power converter as specified in claim 13 wherein the battery is user replaceable.

17. The power converter as specified in claim 11 wherein the battery is user replaceable.

18. The power converter as specified in claim 16 wherein the battery comprises an alkaline or Lithium Ion battery.

19. The power converter as specified in claim 17 wherein the battery comprises a Lithium Ion or Lithium Polymer battery.
